(19) United States
(12) Patent Application Publication
(10) Pub. No.: US 2019/0103940 A1
(43) Pub. Date: Apr. 4, 2019

(54) SECURING BLUETOOTH COMMUNICATIONS USING MULTIPLE ANTENNAS

(71) Applicant: QUALCOMM Incorporated, San Diego, CA (US)

(72) Inventors: Sandipan KUNDU, Santa Clara, CA (US); Le LUONG, San Diego, CA (US)

(21) Appl. No.: 15/724,653

(22) Filed: Oct. 4, 2017

(51) Int. Cl. H04K 3/00; H04W 4/00

(52) U.S. Cl. CPC H04K 3/825; H04W 88/02; H04W 4/008

(57) ABSTRACT

A method for securing Bluetooth communications. The method includes receiving, by a target wireless device, a security level indication from a source wireless device using one or more receiver antennas of the target wireless device. The method also includes determining, by the target wireless device, a jammer signal power level based on the security level indication and generating, by the target wireless device, the jammer signal based on the jammer signal power level. The method also includes transmitting, by the target wireless device, the jammer signal using one or more transmitter antennas of the target wireless device and receiving at least a portion of a communication from the source wireless device using the one or more receiver antennas of the target wireless device.

### TECHNICAL FIELD

The present disclosure relates generally to wireless communications, and more particularly, to systems and methods for securing Bluetooth communications using multiple antennas.

### BACKGROUND

In the last several decades, the use of wireless devices has become common. In particular, advances in electronic technology have reduced the cost of increasingly complex and useful wireless devices. Cost reduction and consumer demand have proliferated the use of wireless devices such that they are practically ubiquitous in modern society.

Wireless devices may make use of one or more wireless communication technologies. For example, a wireless device may communicate using Bluetooth technology. The use of Bluetooth technology in wireless devices has expanded exponentially in the last several years extending to use in offices, homes, cars, personal and general public gathering places.

As the use of Bluetooth wireless devices has grown, so has the need of securing the communications between wireless devices from third party eavesdroppers that may try to intercept the communications. This becomes even more important when the communications involve financial, business, personal, health or other highly sensitive information. Accordingly, a need exists for a way to secure Bluetooth communications between wireless devices that will thwart any third party eavesdropper from intercepting the communications.

### SUMMARY

In an aspect of the present disclosure, a method for securing Bluetooth communications is described. The method includes receiving, by a target wireless device, a security level indication from a source wireless device using one or more receiver antennas of the target wireless device. The method also includes determining, by the target wireless device, a jammer signal power level based on the security level indication and generating, by the target wireless device, the jammer signal based on the jammer signal power level. The method also includes transmitting, by the target wireless device, the jammer signal using one or more transmitter antennas of the target wireless device and receiving at least a portion of a communication from the source wireless device using the one or more receiver antennas of the target wireless device.

The security level indication indicates the security level required in order for the source wireless device to transmit communications to the target wireless device. Determining a jammer signal power level is based at least one or a combination of communication network metrics, proximity and/or number of eavesdropper wireless devices, signal security level, wireless device hardware and/or software metrics, proximity metrics, or signal quality metrics. Transmitting the jammer signal and receiving at least a portion of the communication includes transmitting the jammer signal before, after, or at the same time the at least a portion of the communication is received at the wireless device. In certain configurations, transmitting the jammer signal further includes transmitting one or more additional jammer signals.

In another aspect of the present disclosure, an apparatus for securing Bluetooth communications is described. The apparatus includes a receiver of a target wireless device receiving a security level indication from a source wireless device using one or more receiver antennas of the target wireless device. The apparatus also includes a jammer signal generator of the target wireless device determining a jammer signal power level based on the security level indication and generating the jammer signal based on the jammer signal power level. The apparatus also includes a transmitter of the target wireless device transmitting the jammer signal using one or more transmitter antennas of the target wireless device and receiving at least a portion of a communication from the source wireless device using the one or more receiver antennas of the target wireless device.

In another aspect of the present disclosure, an apparatus for securing Bluetooth communications is described. The apparatus includes means for receiving, by a target wireless device, a security level indication from a source wireless device using one or more receiver antennas of the target wireless device. The apparatus also includes means for determining, by the target wireless device, a jammer signal power level based on the security level indication and means for generating, by the target wireless device, the jammer signal based on the jammer signal power level. The apparatus also includes means for transmitting, by the target wireless device, the jammer signal using one or more transmitter antennas of the target wireless device and receiving at least a portion of a communication from the source wireless device using the one or more receiver antennas of the target wireless device.

In another aspect of the present disclosure, a non-transitory tangible computer readable medium for securing Bluetooth communications is described. The computer readable medium includes storing computer executable code for causing receiving, by a target wireless device, a security level indication from a source wireless device using one or more receiver antennas of the target wireless device. The non-transitory tangible computer readable medium also includes code for causing determining, by the target wireless device, a jammer signal power level based on the security level indication and code for causing generating, by the target wireless device, the jammer signal based on the jammer signal power level. The non-transitory tangible computer readable medium also includes code for causing transmitting, by the target wireless device, the jammer signal using one or more transmitter antennas of the target wireless device and receiving at least a portion of a communication from the source wireless device using the one or more receiver antennas of the target wireless device.

### BRIEF DESCRIPTION OF THE DRAWINGS

FIG. 1 is a block diagram illustrating one configuration of a wireless communication system in which the communications between a source wireless device and a target wireless device are attempting to be intercepted by an eavesdropper wireless device.

FIG. 2 is a flow diagram illustrating a configuration of a method for securing Bluetooth communications.

FIG. 3 is a flow diagram illustrating the detailed configuration options of a method for securing Bluetooth communications.

FIG. 4 is a block diagram illustrating one configuration of a jammer signal generator and jammer signal cancellation.

FIG. 5 illustrates certain components that may be included within a wireless device.

### DETAILED DESCRIPTION

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

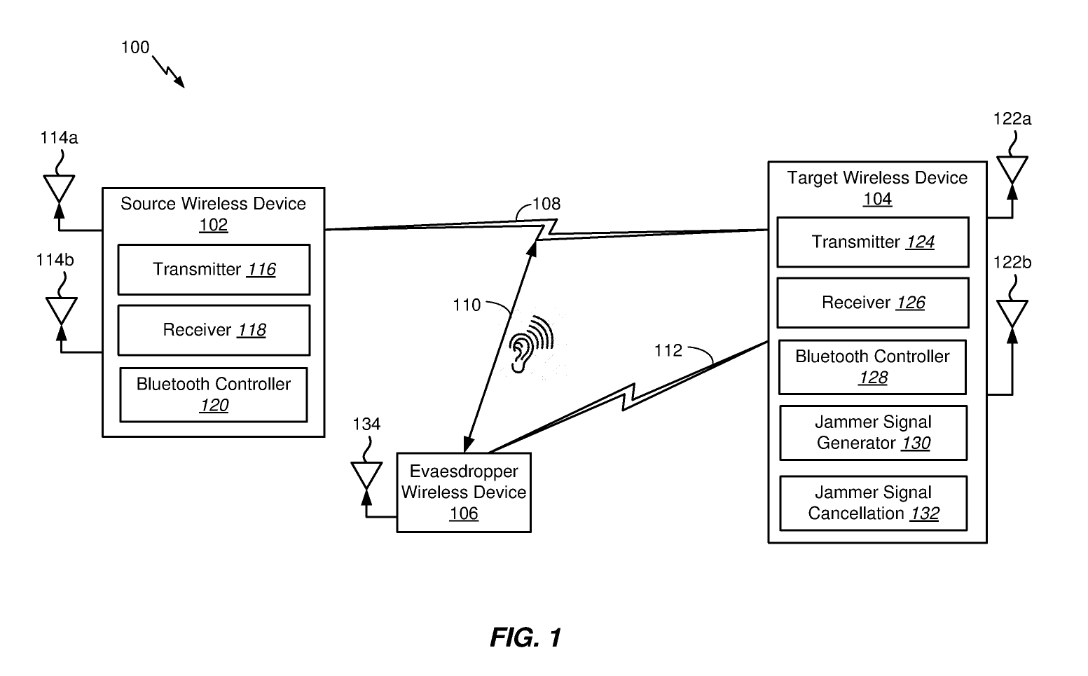

FIG. 1 is a block diagram illustrating one configuration of a wireless communication system 100 in which the communications between a source wireless device 102 and a target wireless device 104 are attempting to be intercepted by an eavesdropper wireless device 106. The wireless communication system 100 is widely deployed to provide various types of communications including audio, data, video, voice, packet, signals, and the like.

Some wireless devices may utilize multiple communication technologies. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), IEEE 802.15.4, IEEE 802.11 (Wi-Fi) networks, Bluetooth (BT) networks, wireless Universal Serial Bus (USB) networks, etc.).

Communications in a wireless communication system 100 (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receiver antennas for data transmission. SISO and MISO systems are particular instances of a MIMO system. The MIMO system can provide improved performance (e.g., higher throughput, greater capacity or improved reliability) if the additional dimensionalities created by the multiple transmit and receiver antennas are utilized.

The source wireless device 102 and target wireless device 104 may also be separately referred to as a wireless device, a mobile device, mobile station, subscriber station, client, client station, user equipment (UE), remote station, access terminal, mobile terminal, terminal, user terminal, subscriber unit, etc. Examples of source wireless device 102 and target wireless device 104 include laptop or desktop computer, cellular phone, smartphone, wireless modem, e-reader, tablet device, gaming system, keyboard, keypad, computer mice, remote controller, headset, headphone, automobile hands-free audio system, etc. The source wireless device 102 and target wireless device 104 can be configured to communicate with any of the wireless communication systems discussed above to transmit signals and/or packets.

In an implementation, the source wireless device 102 and target wireless device 104 may be configured to communicate using Bluetooth protocols. The source wireless device 102 and target wireless device 104 configured to communicate using Bluetooth communications can establish links with one or more wireless devices that have Bluetooth transceivers. Bluetooth is a packet-based protocol with a master-slave structure. Bluetooth operates in the Industrial, Scientific and Medical (ISM) 2.4 GHz short-range radio frequency band (e.g., 2400-2483.5 MHz). Bluetooth uses a radio technology called frequency-hopping spread spectrum in which transmitted data is divided into packets and each packet is transmitted on a designated Bluetooth frequency (e.g., channel).

Communications in a Bluetooth network may be achieved based on a master polled system. The master polled system may utilize time-division duplexing (TDD) in which the source wireless device 102 may send a packet to the target wireless device 104. For example, the source wireless device 102 may send a packet to the target wireless device 104 during pairing or during a connection request. In one implementation, the source wireless device 102 may be a master device and the target wireless device 104 may be a slave device. In a master polled system, the source wireless device 102 sending the packet gives the slave target wireless device 104 the ability to transmit back. The roles of the source wireless device 102 and target wireless device 104 may be switched where the source wireless device 102 becomes the slave device and the target wireless device 104 becomes the master device.

The Bluetooth wireless communication standard is typically employed for exchanging communications between fixed or mobile Bluetooth-enabled devices over short distances. In some configurations, the systems and methods disclosed herein may be applied to Bluetooth Low Energy (BLE) devices. LE refers to the “Low Energy” extension of the Bluetooth standard. The BLE extension is focused on energy-constrained applications such as battery-operated devices, sensor applications, etc. The BLE extension may also be referred to as Bluetooth Smart.

The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices that may not conform to Bluetooth standards.

The use of wireless devices that utilize Bluetooth communications has grown significantly in the past several years. This has resulted in people using Bluetooth communications for the transmission of more sensitive information. This has opened the door for third party individuals wanting to intercept these communications for nefarious purposes. So it is beneficial to provide a way to secure Bluetooth communications from third party eavesdroppers who attempt to intercept communications between wireless devices.

In one scenario, the source wireless device 102 transmits a communication via communication link 108 to the target wireless device 104. The eavesdropper wireless device 106 attempts to intercept the communication by listening for and receiving the communication via communication link 110. The eavesdropper wireless device 106 may be successful at intercepting the communications from communication link 108. To combat the risk of this happening, the target wireless device 104 can generate and transmit a jammer signal 112 that will interfere with the eavesdropper wireless device 106 ability to intercept the communications sent over communication link 108. The target wireless device 104 can generate the jammer signal 112 after receiving a security level indication from the source wireless device 102 and then determining the jammer signal power level. The target wireless device 104 transmits the jammer signal 112 and receives at least a portion of a communication from the source wireless device 102.

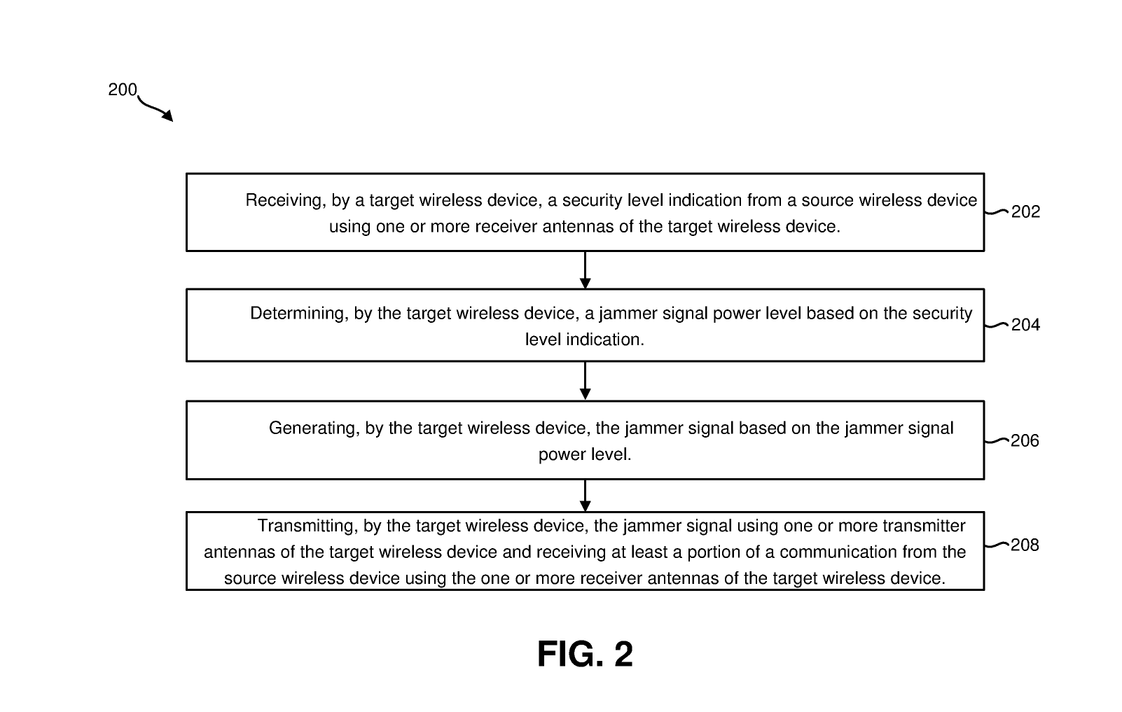

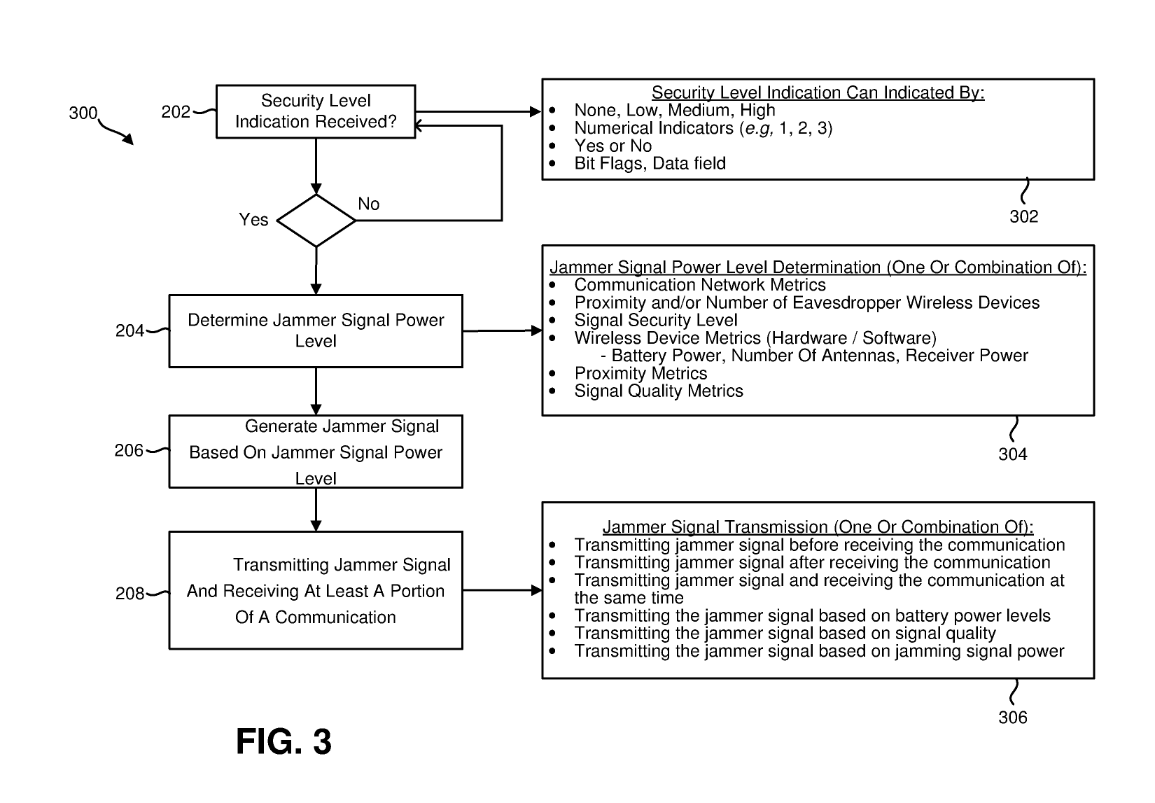

The communication between the source wireless device 102 and target wireless device 104 are made up of signals and/or packets. The at least one portion of the communication can be a full or partial signal and/or packet. In one implementation, the at least one portion of a communication can be a synchronization sequence of the packet or a synchronization sequence of the packet plus a portion of the payload of the packet. The content of the at least one portion of the communication can be made up of audio, data, metrics, protocols, video, voice, and the like. For example, the at least one portion of a communication can be just the beginning portion of a signal and/or packet. The at least one portion of a communication can also be a single and/or multiple signals, packets, or other wireless communications. The security level indication and jammer signal power level determination, generation, and transmission are discussed in detail in the flow diagram and accompanying description in FIG. 2 and FIG. 3.

The source wireless device 102 and target wireless device 104 may include one or more transmitters 116 and 124, one or more receivers 118 and 126, Bluetooth controller 120 and 128, jammer signal generator 130 (optionally can be included in source wireless device 102), jammer signal cancellation 132 (optionally can also be included in source wireless device 102), and one or more antennas 114a-114b and 122a-122b.

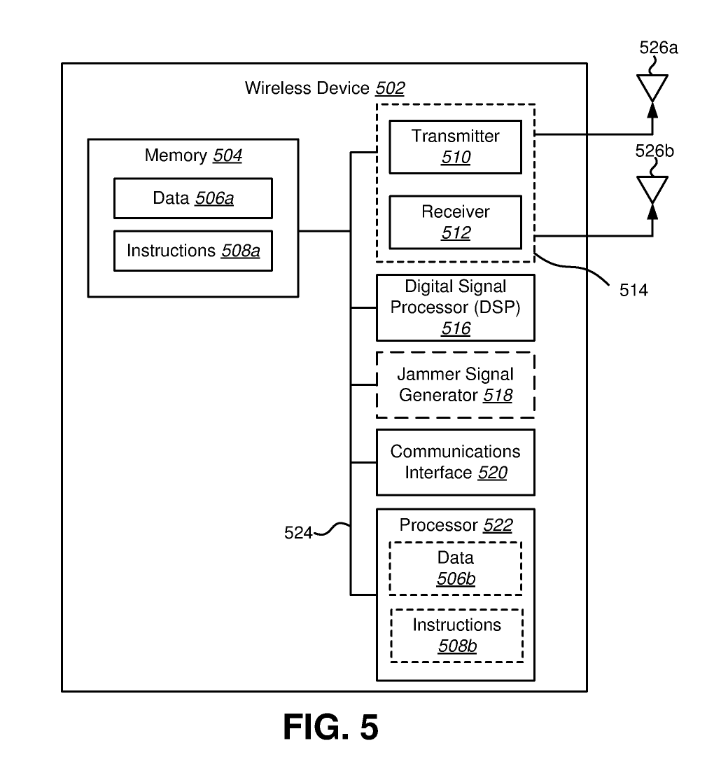

The source wireless device 102 and target wireless device 104 will also include additional software and hardware as further detailed in the wireless device in FIG. 5 which may also include one or more transmitters and receivers, processor(s), memory, antennas, digital signal processor(s), communications interface, user interface, operating systems, and related subsystems required to operate and implement the methods described in the source wireless device 102 and target wireless device 104.

The source wireless device 102 and target wireless device 104 include one or more transmitters 116 and 124 and one or more receivers 118 and 126 are included to allow transmissions and reception of communication to and from each wireless device via antennas 114a-114b and antennas 122a-122b. The antennas 114a-114b and 122a-122b are representative and may include one or more transmitter antennas and one or more receiver antennas on each wireless device. The particular antenna configurations for 114a-114b and 122a-122b will have at a minimum one transmitter antenna and one receiver antenna on each wireless device. In one implementation, there may be multiple transmitter antennas and multiple receiver antennas on a single wireless device to enhance data transmissions and reception such as source wireless device 102 and target wireless device 104.

The Bluetooth controller 120 and 128 may interface with additional components within the source wireless device 102 and target wireless device 104. The Bluetooth controller 120 and 128 may communicate with other wireless devices. The Bluetooth controller 120 and 128 may include a Bluetooth transceiver that can establish a radio link with other wireless devices such as source wireless device 102 and target wireless device 104 using one or more of a link layer control procedure or a link manager protocol.

The target wireless device 104 additionally includes the jammer signal generator 130 and jammer signal cancellation 132. The source wireless device 102 can optionally also include the jammer signal generator 130 and the jammer signal cancellation 132. The jammer signal generator 130 includes any necessary hardware and software that is needed to perform the determination of the jammer signal power level and generation of the jammer signal. For example, the jammer signal generator 130 can include control logic that is able to perform the determination of the jammer signal power level. Alternatively, the determination of the jammer signal power level can also be performed by control logic in the target wireless device 104 such as a processor with memory as detailed in FIG. 5.

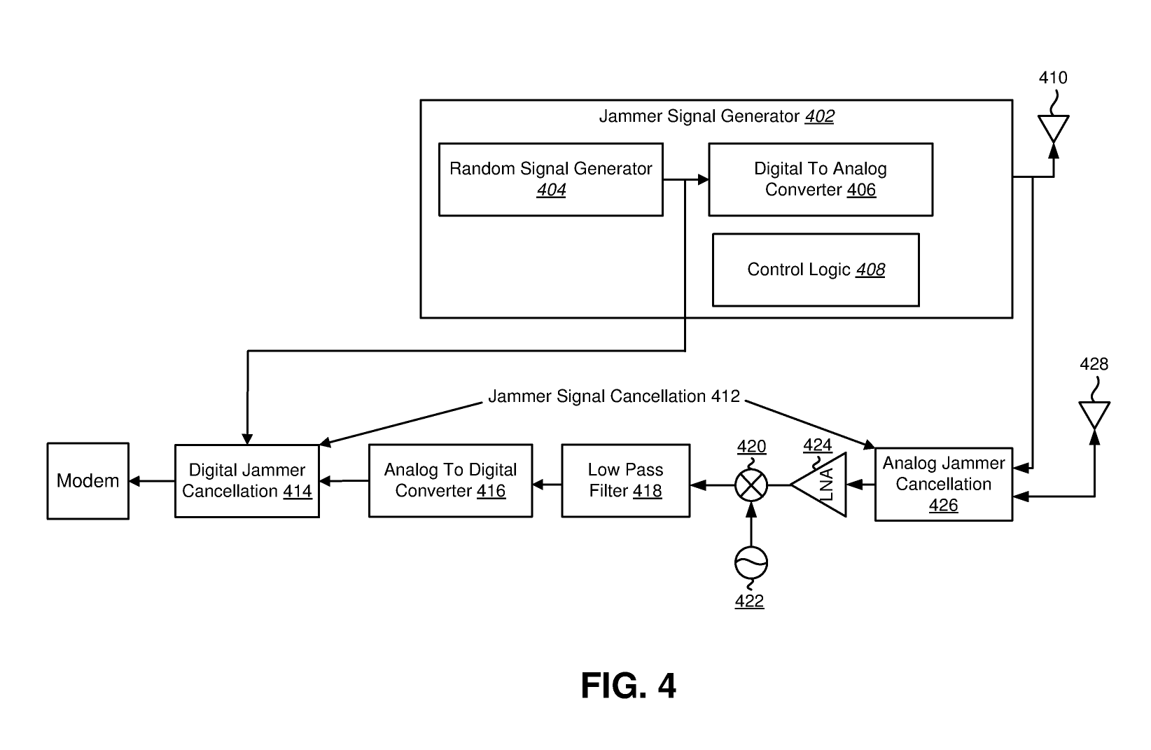

The jammer signal cancellation 132 includes any necessary hardware and software that is needed to perform the cancellation of any jammer signals 112 received by target wireless device 104. For example, when the target wireless device 104 transmits the jammer signal 112, the target wireless device 104 may also receive the jammer signal 112 in the process of receiving communications from source wireless device 102. In this case, the jammer signal cancellation 132 can remove the jammer signal 112 from the received communications. An implementation of the jammer signal generator 130 and jammer signal cancellation 132 are illustrated in FIG. 4 along with a more detailed technical description.

The eavesdropper wireless device 106 can be include the same and/or similar hardware and software configuration as the source wireless device 102 and target wireless device 104. The eavesdropper wireless device 106 can use one or more antennas 134 to transmit and receive signals over communication link 110. The one or more antennas 134 includes at least one transmit antenna and at least one receiver antenna. The eavesdropper wireless device 106 uses the one or more antennas 134 to try to receive and intercept communication between the source wireless device 102 and target wireless device 104. The eavesdropper wireless device 106 can also be configured with additional hardware or software that will allow the device to specifically detect and intercept any or all communications sent or received by a wireless device including source wireless device 102 and target wireless device 104.

The described systems and methods can increase the ability of the source wireless device 102 and the target wireless device 104 to combat the ability of the eavesdropper wireless device 106 from intercepting any communications they have via communication link 108. This helps to ensure that users of wireless devices can perform Bluetooth communications with a higher degree of confidence knowing the communication can be blocked from being intercepted by an eavesdropper device.

FIG. 2 is a flow diagram illustrating a configuration of a method for securing Bluetooth communications. This method 200 may be implemented by a target wireless device 104 that communicates with source wireless device 102 over communication link 108. A minimized version of this method 300 is detailed in the flow diagram in FIG. 3 with a focus on specific criteria that can be selected and implemented for each full step shown in FIG. 2. The criteria from FIG. 3 will be referenced in the applicable portions of the description of FIG. 2.

In one scenario as detailed in FIG. 1, the source wireless device 102 transmits communications to the target wireless device 104 over communication link 108. During these communications, the eavesdropper wireless device 106 attempts to intercept the communications by listening for and receiving communications from communication link 108 via communication link 110. The eavesdropper wireless device 106 may be successful at intercepting the communications over communication link 110. To combat the risk of the communications being intercepted, the following steps can be implemented.

At 202, the target wireless device 104 receives a security level indication 302 from the source wireless device 102 over communication link 108 using one or more receiver antennas 122a-122b of the target wireless device 102. The security level indication 302 indicates the security level required in order for the source wireless device 102 to transmit communications to the target wireless device 104.

The security level indication 302 can be any form of indication that can be communicated from the source wireless device 102 to the target wireless device 104. For example, the security level indication 302 can be included in a data packet, signal, or other communication type. The security level indication 302 can be a set of nomenclature (e.g., none, low, medium, high, yes or no), numbers (e.g., 1, 2, 3), bit flags, or other indicators that can indicate a security level.

At 204, the target wireless device 104 determines a jammer signal power level 304 based on the security level indication 302. The jammer signal power level 304 is representative of the power level that the jammer signal 112 will be transmitted at from the target wireless device 104.

The jammer signal power level 304 can be based on the security level indication 302 and/or a combination of other metrics and factors including, but not limited to, communication network metrics, proximity and/or number of eavesdropper wireless devices, proximity metrics, signal quality metrics, and wireless device metrics (hardware/software) such as battery power, number of antennas, receiver power, and the like. The jammer signal power level 304 can be dynamically adjusted by the target wireless device 104 at any time. The dynamic adjustment may be based on any one or combination of the factors detailed above.

The jammer signal power level 304 can be correlated to the security level indication 302. In one implementation, a security level indication is received showing that a high level of security is needed for receiving the communication. The required high level of security can result in the jammer signal power level 304 being elevated to a higher level than a security level indication 302 of a medium level of security.

In one implementation, the source wireless device 102 does not send a security level indication 302. In certain scenarios or based on certain metrics, the jammer signal power level 304 can be determined by the target wireless device 104 without correlation to a security level indication 302.

The target wireless device 104 can determine a jammer signal power level 304 based on the security level indication 302. The target wireless device 104 uses the security level indication 302 and then makes a determination on the actual power level that the jammer signal 112 will be transmitted to the eavesdropper wireless device 106. The jammer signal power level 304 can be dynamically adjusted by the target wireless device 104 at any time.

The target wireless device 104 can then generate a jammer signal 112 based on the jammer signal power level 304. The jammer signal 112 can interfere with the eavesdropper wireless device 106 ability to intercept the communications from communication link 108. The jammer signal power level can be dynamically changed at any time in order to transmit a high enough power jammer signal 112 that will corrupt, over power, or otherwise interfere with the eavesdropper wireless device 106 to intercept any communications 110 transmitted between the source wireless device 102 and target wireless device 104 over communication link 108.

At 206, the target wireless device 104 can generate the jammer signal 112 based on the jammer signal power level 304. The target wireless device 104 generates the jammer signal 112 with the jammer signal generator 130 as detailed in FIG. 1 and FIG. 4. The target wireless device 104 can dynamically transmit the jammer signal 112 which allows the target wireless device 104 to closely control the jammer signal 112. This means that the target wireless device 104 can on the fly change or modify the jammer signal 112. For example, the modifications could be changing the number of jammer signals transmitted, the time between jammer signal transmissions, power level of each jammer signal transmission, length of each jammer signal transmission, and the like. The target wireless device 104 can make these dynamic changes based on additional feedback from the source wireless device 102 and/or other communication metrics received or detected by the target wireless device 104.

In one implementation, the target wireless device 104 transmits the jammer signal 112 for a specific amount of time and power level. The target wireless device 104 can then dynamically make adjustments to the jammer signal 112 power level after it detects changes in communications network, communication link 108, eavesdropper wireless device 106, or receives a new and/or updated security level indication 302. In another implementation, the target wireless device 104 has generated and transmitted a jammer signal 112. The target wireless device 104 receives an updated security level indication from the source wireless device 102 that indicates a need to increase the security level due to transmission of sensitive data. The target wireless device 104 can then generate a more powerful jammer signal 112 that will help to interfere with the eavesdropper wireless device 106 from receiving the sensitive communication.

At 208, the target wireless device 104 transmits the generated jammer signal 112 using one or more transmitter antennas 122a-122b of the target wireless device 104 and receiving at least a portion of a communication from the source wireless device 102 using the one or more receiver antennas 122a-122b of the target wireless device.

The jammer signal 112 can be transmitted at different times than when the at least one portion of communication is received at the target wireless device 104. For example, the jammer signal 112 can be transmitted before, after, or at the same time the at least a portion of the communication is received at the target wireless device 104.

In another example, the jammer signal 112 can be transmitted based on the target wireless device 104 battery power levels, signal quality, jamming signal power, number of jammer signals transmitted and the like. In one implementation, the target wireless device 104 transmits the jammer signal 112 and the target wireless device 104 battery power levels fall below a specific threshold. The target wireless device 104 then can dynamically adjust the power level of the jammer signal 112 in correlation with the battery power levels of the target wireless device 104. In another implementation, the target wireless device 104 terminates transmitting the jammer signal 112 based on different factors such as power levels, updated security level indication, etc. In another implementation, the target wireless device 104 can transmit more than one jammer signals at the same time and/or one after another.

In one implementation, the target wireless device 104 can send a transmit acknowledgement to the source wireless device 104 to instruct the source wireless device 104 to start transmitting communications. The target wireless device 104 can send this transmit acknowledgement at any time. For example, the target wireless device 104 can send the transmit acknowledgement after receiving the security level indicator, before or after determining the jammer signal power level, before or after generating the jammer signal, and/or before transmitting the jammer signal. The transmit acknowledgement can also be sent by the target wireless device 104 during any time in steps 202, 204, 206, or 208 shown in FIG. 2. In another implementation, the source wireless device 102 can send the transmit acknowledge in any of the same configurations or manners as the target wireless device 104 discussed above.

After the target wireless device 104 transmits the jammer signal 112, the target wireless device 104 may receive one or more communications from the source wireless device 102. In one implementation, the one or more communications can also include the jammer signal 112 that was transmitted by the target wireless device 104. In this case, the jammer signal 112 will need to be cancelled by the target wireless device 104. The target wireless device 104 includes hardware and software required to cancel one or more jammer signals 112 that it receives. For example, the target wireless device 104 includes the jammer signal cancellation 132 to carry out these functions as further detailed in FIG. 4 and the accompanying description.

FIG. 4 is a block diagram illustrating one configuration of a jammer signal generator 402 and jammer signal cancellation 412. The jammer signal generator 402 and jammer signal cancellation 412 can be implemented in different configurations of hardware and software combinations in reference to jammer signal generator 130 and jammer signal cancellation 132 shown in FIG. 1. In one implementation, the jammer signal generator 402 includes random signal generator 404, digital to analog converter 406, control logic 408, and other required signal generator blocks. The jammer signal generator 402 can use of one or more transmitter antennas 410 for transmitting the generated jammer signal. The jammer signal generator 402 generates random single and/or multi-carrier modulated narrow and/or wideband noise.

The jammer signal cancellation 412 can cancel out any jammer signal 112 that is received over one or more receiver antennas 428. The jammer signal cancellation 412 cancels received jammer signals 112 by a combination of analog and digital domain techniques. In one implementation, the jammer signal cancellation 412 can include both an analog jammer cancellation 426 and a digital jammer cancellation 414. In another implementation, the jammer signal cancellation 412 can include just an analog jammer cancellation 426. In another implementation, the jammer signal cancellation 412 can include just a digital jammer cancellation 414. For reference purposes, components of a receiver are shown (analog to digital converter 416, low pass filter 418, mixer 420, carrier generator 422, and LNA 424) to illustrate where the jammer signal generator 402 and jammer signal cancellation 412 would be implemented.

FIG. 5 illustrates certain components that may be included within a wireless device 502. The wireless device 502 may be a wireless communication device, an access terminal, a mobile station, a user equipment (UE), a laptop computer, a desktop computer, a tablet computer, computer, mobile phone, smartphone, a wireless headset, and the like. For example, the wireless device 502 may be implemented in accordance with the source wireless device 102, target wireless device 104, and eavesdropper wireless device 106.

The wireless device 502 includes a processor 522. The processor 522 may be a general purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 522 may be referred to as a central processing unit (CPU). Although just a single processor 522 is shown, a combination of processors (e.g., an ARM and DSP) could be used.

The wireless device 502 also includes memory 504 in electronic communication with the processor (i.e., the processor can read information from and/or write information to the memory). The memory 504 may be any electronic component capable of storing electronic information. The memory 504 may be configured as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers and so forth, including combinations thereof.

Data 506a and instructions 508a may be stored in the memory 504. The instructions may include one or more programs, routines, sub-routines, functions, procedures, code, etc. The instructions may include a single computer-readable statement or many computer-readable statements. The instructions 508a may be executable by the processor 522 to implement the methods disclosed herein. Executing the instructions 508a may involve the use of the data 506a that is stored in the memory 504. When the processor 522 executes the instructions 508a, various portions of the instructions 508b may be loaded onto the processor 522, and various pieces of data 506b may be loaded onto the processor 522.

The wireless device 502 may also include a transmitter 510 and a receiver 512 to allow for transmission and reception of signals to and from the wireless device 502 via one or more antennas 526a-526b. The transmitter 510 and receiver 512 may be collectively referred to as a transceiver 514. The wireless device 502 may also include (not shown) multiple transmitters, multiple receivers and/or multiple transceivers.

The antennas 526a-526b may include one or more transmitter antennas and one or more receiver antennas. The particular antenna configurations for the wireless device 502 can be based on the number of transmitters and receivers included in the wireless device 502 along with the particular communication network and other factors. In one implementation, there may be multiple transmitter antennas and multiple receiver antennas on a single wireless device.

The wireless device 502 may include a digital signal processor (DSP) 516. The wireless device 502 may also include a communications interface 520. The communications interface 520 may allow a user to interact with the wireless device 502.

The various components of the wireless device 502 may be coupled together by one or more buses, which may include a power bus, a control signal bus, a status signal bus, a data bus, etc. For the sake of clarity, the various buses are illustrated in FIG. 5 as a bus system 524.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C.

As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for securing Bluetooth communications:
receiving, by a target wireless device, a security level indication from a source wireless device using one or more receiver antennas of the target wireless device;
determining, by the target wireless device, a jammer signal power level based on the security level indication;
generating, by the target wireless device, the jammer signal based on the jammer signal power level; and
transmitting, by the target wireless device, the jammer signal using one or more transmitter antennas of the target wireless device and receiving at least a portion of a communication from the source wireless device using the one or more receiver antennas of the target wireless device.

2. The method of claim 1, wherein the security level indication indicates the security level required in order for the source wireless device to transmit communications to the target wireless device.

3. The method of claim 1, wherein determining a jammer signal power level is based on at least one or a combination of communication network metrics, proximity of eavesdropper wireless devices, number of eavesdropper wireless devices, signal security level, wireless device hardware metrics, wireless device software metrics, proximity metrics, or signal quality metrics.

4. The method of claim 1, wherein transmitting the jammer signal and receiving at least a portion of the communication includes transmitting the jammer signal before, after, or at the same time the at least a portion of the communication is received at the target wireless device.

5. The method of claim 1, wherein transmitting the jammer signal further includes transmitting one or more additional jammer signals.

6. An apparatus for securing Bluetooth communications:
receiver of a target wireless device receiving a security level indication from a source wireless device using one or more receiver antennas of the target wireless device;
jammer signal generator of the target wireless device determining a jammer signal power level based on the security level indication and generating the jammer signal based on the jammer signal power level; and
transmitter of the target wireless device transmitting the jammer signal using one or more transmitter antennas of the target wireless device and receiving at least a portion of a communication from the source wireless device using the one or more receiver antennas of the target wireless device.

7. The apparatus of claim 6, wherein the security level indication indicates the security level required in order for the source wireless device to transmit communications to the target wireless device.

8. The apparatus of claim 6, wherein determining a jammer signal power level is based on at least one or a combination of communication network metrics, proximity of eavesdropper wireless devices, number of eavesdropper wireless devices, signal security level, wireless device hardware metrics, wireless device software metrics, proximity metrics, or signal quality metrics.

9. The apparatus of claim 6, wherein transmitting the jammer signal and receiving at least a portion of the communication includes transmitting the jammer signal before, after, or at the same time the at least a portion of the communication is received at the target wireless device.

10. The apparatus of claim 6, wherein transmitting the jammer signal further includes transmitting one or more additional jammer signals.

11. An apparatus for securing Bluetooth communications:
means for receiving, by a target wireless device, a security level indication from a source wireless device using one or more receiver antennas of the target wireless device;
means for determining, by the target wireless device, a jammer signal power level based on the security level indication;
means for generating, by the target wireless device, the jammer signal based on the jammer signal power level; and
means for transmitting, by the target wireless device, the jammer signal using one or more transmitter antennas of the target wireless device and receiving at least a portion of a communication from the source wireless device using the one or more receiver antennas of the target wireless device.

12. The apparatus of claim 11, wherein the security level indication indicates the security level required in order for the source wireless device to transmit communications to the target wireless device.

13. The method of claim 11, wherein determining a jammer signal power level is based on at least one or a combination of communication network metrics, proximity of eavesdropper wireless devices, number of eavesdropper wireless devices, signal security level, wireless device hardware metrics, wireless device software metrics, proximity metrics, or signal quality metrics.

14. The apparatus of claim 11, wherein transmitting the jammer signal and receiving at least a portion of the communication includes transmitting the jammer signal before, after, or at the same time the at least a portion of the communication is received at the target wireless device.

15. The apparatus of claim 11, wherein transmitting the jammer signal further includes transmitting one or more additional jammer signals.

16. A non-transitory tangible computer readable medium storing computer executable code, comprising:
code for causing receiving, by a target wireless device, a security level indication from a source wireless device using one or more receiver antennas of the target wireless device;
code for causing determining, by the target wireless device, a jammer signal power level based on the security level indication;
code for causing generating, by the target wireless device, the jammer signal based on the jammer signal power level; and
code for causing transmitting, by the target wireless device, the jammer signal using one or more transmitter antennas of the target wireless device and receiving at least a portion of a communication from the source wireless device using the one or more receiver antennas of the target wireless device.

17. The computer readable medium of claim 16, wherein the security level indication indicates the security level required in order for the source wireless device to transmit communications to the target wireless device.

18. The computer readable medium of claim 16, wherein determining a jammer signal power level is based on at least one or a combination of communication network metrics, proximity of eavesdropper wireless devices, number of eavesdropper wireless devices, signal security level, wireless device hardware metrics, wireless device software metrics, proximity metrics, or signal quality metrics.

19. The computer readable medium of claim 16, wherein transmitting the jammer signal and receiving at least a portion of the communication includes transmitting the jammer signal before, after, or at the same time the at least a portion of the communication is received at the target wireless device.

20. The computer readable medium of claim 16, wherein transmitting the jammer signal further includes transmitting one or more additional jammer signals.
